(19) United States
(12) Patent Application Publication
(10) Pub. No.: US 2024/0041681 A1
(43) Pub. Date: Feb. 8, 2024

(54) PERSONAL LIFTING APPARATUS

(71) Applicant: Sheilagh O'Callaghan, Calgary (CA)

(72) Inventor: Sheilagh O'Callaghan, Calgary (CA)

(21) Appl. No.: 17/818,017

(22) Filed: Aug. 8, 2022

(51) Int. Cl. A61G 7/10; G05D 1/02

(52) U.S. Cl. CPC A61G 7/1048; G05D 1/0231; A61G 7/1019; G05D 2201/0212; A61G 2200/36; A61G 2203/12; A61G 2203/30

(57) ABSTRACT

A lifting apparatus configured to autonomously traverse to a location proximate a fallen individual and provide assistance to the fallen individual so as to return the fallen individual to a standing position. The lifting apparatus of the present invention includes a movement assembly operable to provide the required directional movement to traverse to a fallen individual. The present invention includes a mapping module that provides objection detection operable to inhibit the lifting apparatus from colliding with objects during the process of traversing to a fallen individual. A vitals sign monitoring module is deployed to provide accurate detection of the fallen individual distinguishing from an inanimate object. A voice recognition module is provided and is configured to facilitate voice operation of the lifting apparatus. A lifting member is movable between a first and second position and is configured to provide support for a fallen individual.

### FIELD OF THE INVENTION

The present invention relates generally to a personal assistance device, more specifically but not by way of limitation, a personal lifting apparatus that is voice operated wherein subsequent an individual falling and being on the floor the present invention can locate, traverse to and assist in getting the individual back to a standing position.

### BACKGROUND

As is known in the art there are hundreds of thousands of falls in homes and other facilities every year. Falls account for a significant portion of emergency calls every year. As the populations in many countries are aging these falls have placed a great burden on local emergency services. Many times the individuals that fall are not injured but are unable to return themselves to a sitting or standing position. Once an individual falls if they are unable to get back up under their own power, it results in either a safety issue for the person or a burden on alternate resources such as but not limited to local emergency personnel to assist the fallen individual. When patients and/or individuals fall in healthcare facilities it can present not only challenges to the workers to return the patient back to a sitting or standing position but can further present liability concerns.

One problem that individuals have ensuing falling is the lack of a tool or apparatus that can provide them assistance without the need for any other individual. Many elderly individuals will take training classes to teach them to help themselves to return to a sitting then standing position. While these techniques and classes can help, there are many scenarios wherein the techniques require use of a piece of furniture or other object and the individual has fallen in a location where furniture or other object is not available. As such the individual must either wait for emergency personnel or depend on another person to help them return to a standing position. There is further additional risk wherein the person helping the fallen individual may injure themselves when attempting to help the fallen individual return to a standing position.

Accordingly, there is a need for personal lifting device that can provide an individual assistance in returning to a standing position wherein the present invention is configured to locate and traverse to the fallen individual.

### SUMMARY OF THE INVENTION

It is the object of the present invention to provide a personal lifting device that is operable to assist a fallen individual to return to a standing position wherein the present invention is configured to be mobile and traverse under its own power.

Another object of the present invention is to provide a lifting apparatus that is configured to locate, traverse to and assist a fallen individual wherein the present invention includes a base having an electric motor and wheels.

A further object of the present invention is to provide a personal lifting device that is operable to assist a fallen individual to return to a standing position wherein the present invention is configured with objection detection radar to identify objects proximate to the present invention.

Still another object of the present invention is to provide a lifting apparatus that is configured to locate, traverse to and assist a fallen individual wherein the present invention includes a base platform wherein the base platform is movable between a stored and a deployed position.

An additional object of the present invention is to provide a personal lifting device that is operable to assist a fallen individual to return to a standing position wherein the present invention further includes a vital sign monitoring module wherein the vital sign monitoring module is configured to assist in locating a fallen individual.

Yet a further object of the present invention is to provide a lifting apparatus that is configured to locate, traverse to and assist a fallen individual wherein the present invention further includes voice recognition and voice locating modules.

Another object of the present invention is to provide a personal lifting device that is operable to assist a fallen individual to return to a standing position wherein the base of the present invention further includes a plurality of handle members configured to be engaged by a user.

Still another object of the present invention is to provide a lifting apparatus that is configured to locate, traverse to and assist a fallen individual wherein the present invention includes a controller wherein the controller includes mapping capabilities operable to map objects in a room and store information thereon.

An additional object of the present invention is to provide a personal lifting device that is operable to assist a fallen individual to return to a standing position wherein the base platform further includes a cushion member.

Still a further object of the present invention is to provide a lifting apparatus that is configured to locate, traverse to and assist a fallen individual wherein the present invention further includes a base charger that is configured to charge the power supply of the present invention.

Yet another object of the present invention is to provide a personal lifting device that is operable to assist a fallen individual to return to a standing position wherein the present invention can be activated by voice or a remote controller.

A further object of the present invention is to provide a lifting apparatus that is configured to locate, traverse to and assist a fallen individual wherein the present invention is lightweight and transportable.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front perspective view of the present invention with the base platform in its deployed position; and

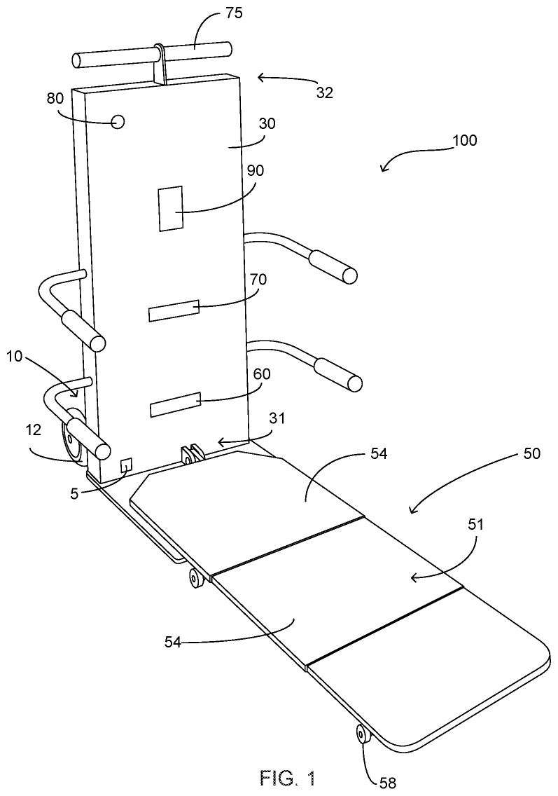

FIG. 2 is a front perspective view of the present invention with the base platform in its stored position.

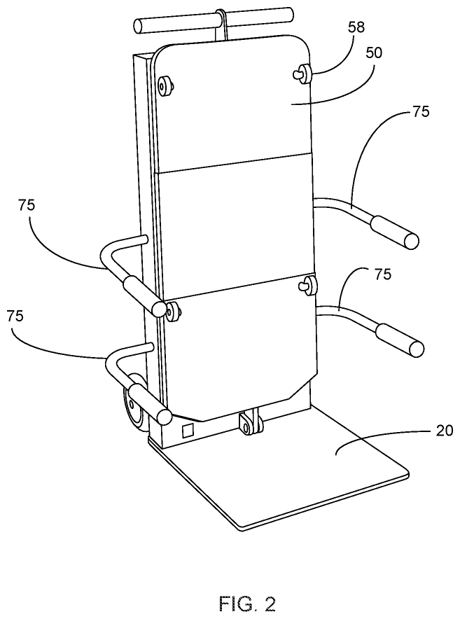

### DETAILED DESCRIPTION

Referring now to the drawings submitted herewith, wherein various elements depicted therein are not necessarily drawn to scale and wherein through the views and figures like elements are referenced with identical reference numerals, there is illustrated a lifting apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the lifting apparatus 100 is illustrated herein in an exemplary embodiment. It should be understood within the scope of the present invention that the lifting apparatus 100 could be constructed in numerous alternate shapes and sizes and achieve the desired functionality described herein. The lifting apparatus 100 includes a movement assembly 10. The movement assembly 10 is operable to provide multi-direction movement of the lifting apparatus 100. Included in the movement assembly 10 are wheels 12 and motor 14. Motor 14 is a direct current electric motor configured to provide independent rotation of the wheels 12 in order to provide movements of the lifting apparatus 100 in a forward direction, rearward direction and rotational direction. It should be understood within the scope of the present invention that the movement assembly 10 could include alternate quantities of wheels 12 in various locations on the lifting apparatus 100 in order to achieve the desired objective discussed herein. Furthermore, it should be understood within the scope of the present invention that the lifting apparatus 100 could employ alternate elements to provide the desired movement thereof.

A base support member 20 is operably coupled to the movement assembly 10. The base support member 20 is planar in manner being manufactured from a rigid material such as but not limited to metal. The base support member 20 provides the necessary structural support for the vertical support member 30 that extends upwards therefrom. It should be understood within the scope of the present invention that the base support member 20 could vary in size and shape. The vertical support member 30 is operably coupled to the base support member 20 and extends upwards therefrom. The vertical support member 30 includes a first end 31 and second end 32. The vertical support member 30 provides support for the lifting member 50. The vertical support member 30 is manufactured from a rigid material such as but not limited to metal. The vertical support member 30 includes an interior volume(not particularly illustrated herein) that is sufficient in size to house a power supply 5, mapping module 60, vitals detection module 70 and voice recognition module 80. Additionally, the controller 90 is disposed within the interior volume of the vertical support member 30. The controller 90 is operably coupled to all of the elements of the present invention and includes the necessary electronics to receive, store, transmit and manipulate data. It should be understood within the scope of the present invention that the vertical support member 30 could be provided in alternate sizes and shapes as well as be configured to be collapsible.

The lifting apparatus 100 includes a mapping module 60. The mapping module 60 is operable to assist in the successful autonomous movement of the lifting apparatus 100 in a residence wherein the mapping module provides object detection so as to avoid potential obstacles as the lifting apparatus 100 is traversing towards a fallen individual in need of assistance. The mapping module 60 includes the necessary electronics to execute visual simultaneous localization and mapping. This provides object detection identification and marking of the location thereof wherein the lifting apparatus 100 during movement can avoid collision with the marked objects. The lifting apparatus 100 further includes a vitals detection module 70. The vitals detection module 70 is employed to provide remote monitoring of vitals such as but not limited to body temperature to facilitate location of an individual needing assistance. As the lifting apparatus 100 is traversing towards an object the vitals detection module 70 can provide further information about the object so as to identify the object as a fallen person that is in need of assistance. Employment of the vitals detection module 70 facilitates a more expedited and accurate arrival of the lifting apparatus 100 to the fallen individual that is in need of assistance. In a preferred embodiment the vitals detection module 70 employs an infrared laser to provide temperature of an object but it is contemplated within the scope of the present invention that the vitals detection module 70 could employ alternate technologies to accomplish the desired objective.

The lifting apparatus 100 further includes a voice recognition module 80. The voice recognition module 80 is operable to detect commands instructing the lifting apparatus 100 to traverse to a fallen individual in need of assistance. Subsequent falling, the fallen individual can speak a command to provide activation of the lifting apparatus 100 in order to initiate the lifting apparatus 100 to traverse towards the fallen individual so as to provide assistance thereto. It is further intended within the scope of the present invention that the voice recognition module is further operable to receive continuous audio instructions so as to allow a user to provide movement directions in order to facilitate the movement of the lifting apparatus 100 to a location adjacent the fallen individual.

The lifting apparatus 100 includes lifting member 50. The lifting member 50 is planar in manner and is rectangular in shape. The lifting member 50 includes a plurality of telescoping segments 54 wherein the telescoping segments 54 provide extension and retraction of the lifting member 50. It should be understood within the scope of the present invention that the lifting member 50 could include alternate quantities of telescoping segments 54. While not illustrated herein, it is contemplated within the scope of the present invention that the lifting member 50 can be configured to expand laterally so as to alter the width thereof as needed. The lifting member 50 includes an upper surface 51 wherein in a preferred embodiment of the lifting member the upper surface 51 is cushioned. The lifting member 50 is movable between a first position and a second position. In the first position the lifting member 50 is upright and adjacent to the vertical support member 30. The first position is utilized when the lifting apparatus 100 is not in use. In the second position the lifting member 50 is moved such that the lifting member 50 extends outward and is perpendicular to the vertical support member 30. The lifting member 50 is movably coupled to the vertical support member 30 so as to traverse in an upwards-downwards direction with respect thereto. The lifting member 50 moves from a position adjacent to a floor in an upwards direction subsequent a fallen person positioning themselves on the upper surface 51. This provides the necessary assistance so that the individual can return to a standing position. It should be understood within the scope of the present invention that the lifting member 50 could be provided in various shapes and sizes and perform the desired objective discussed herein. It should be further understood within the scope of the present invention that the motor 14 provides the necessary power to facilitate the movement of the lifting member 50. The lifting member 50 is further equipped with wheels 58 to facilitate movement thereof.

The vertical support member 30 includes a plurality of handle members 75 operably coupled thereto. The handle members 75 are operably coupled to the vertical support member 30 utilizing suitable mechanical techniques. The handle members 75 are located on opposing sides of the vertical support member 30 and the top so as to provide a plurality of options for a user to engage depending upon their position. While a particular quantity and orientation of the handle members 75 are illustrated herein, it is contemplated within the scope of the present invention that the lifting apparatus 100 could have alternate quantities of handle members 75 and further have alternate orientations thereof to provide the desired functionality discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A lifting apparatus operable to autonomously traverse to a fallen individual and facilitate returning the fallen individual to a standing position wherein the lifting apparatus comprises:
a controller, said controller having electronics configured to receive, store, transmit and manipulate data;
a base support member, said base support member being proximate a bottom of the lifting apparatus, said base support member configured to provide structural support for the lifting apparatus;
a movement assembly, said movement assembly configured to provide multi-directional movement of the lifting apparatus, said movement assembly having an electric motor and a plurality of wheels;
a vertical support member, said vertical support member being operably coupled to said base support member, said vertical support member extending upward from said base member;
a mapping module, said mapping module being operably coupled to said controller, said mapping module configured to provide object localization and mapping thereof during movement of the lifting apparatus; and
a voice module, said voice module being operably coupled to said controller, said voice module configured to receive audio instructions from a user of the lifting apparatus providing operation thereof.

2. The lifting apparatus operable to autonomously traverse to a fallen individual as recited in claim 1, and further including a lifting member, said lifting member being operably coupled to said vertical support member, said lifting member being movable between a first position and a second position, said lifting member being configured in size and shape to accommodate a fallen individual thereon.

3. The lifting apparatus operable to autonomously traverse to a fallen individual as recited in claim 2, and further including a vitals detection module, said vitals detection module being operably coupled to said controller, said vitals detection module configured to measure at least one vital sign of the fallen individual.

4. The lifting apparatus operable to autonomously traverse to a fallen individual as recited in claim 3, wherein in said first position the lifting member is adjacent to said vertical support member.

5. The lifting apparatus operable to autonomously traverse to a fallen individual as recited in claim 4, and further including a plurality of handle members, said plurality of handle members being operably coupled to said vertical support member, said plurality of handle members configured to be engaged by the fallen individual.

6. The lifting apparatus operable to autonomously traverse to a fallen individual as recited in claim 5, wherein in the second position the lifting member extends outward from the vertical support member and is horizontal in orientation allowing a fallen individual to move to an upper surface thereof.

7. A lifting apparatus operable to autonomously traverse to a fallen individual subsequent to receiving voice instructions from the fallen individual in order to assist the fallen individual to a standing position wherein the lifting apparatus comprises:
a controller, said controller having electronics configured to receive, store, transmit and manipulate data;
a base support member, said base support member being proximate a bottom of the lifting apparatus, said base support member configured to provide structural support for the lifting apparatus;
a movement assembly, said movement assembly configured to provide multi-directional movement of the lifting apparatus, said movement assembly having an electric motor and a plurality of wheels;
a vertical support member, said vertical support member being operably coupled to said base support member, said vertical support member extending upward from said base member, said vertical support member being cylindrical in shape having an interior volume;
a mapping module, said mapping module being mounted in said vertical support member, said mapping module being operably coupled to said controller, said mapping module configured to provide visual simultaneous localization and mapping of objects as the lifting apparatus traverses towards the fallen individual; and
a voice module, said voice module being operably coupled to said controller, said voice module being mounted in said vertical support member, said voice module configured to receive audio instructions from the fallen individual providing operation thereof;
a vitals detection module, said vitals detection module being operably coupled to said controller, said vitals detection module configured to measure at least one vital sign of the fallen individual; and
a lifting member, said lifting member being movably coupled to said vertical support member, said lifting member being planar in manner having an upper surface, said lifting member having a first position and a second position, said lifting member operable to receive the fallen individual on a portion thereof.

8. The lifting apparatus operable to autonomously traverse to the fallen individual as recited in claim 7, and further including a plurality of handle members, said plurality of handle members being operably coupled to said vertical support member, said plurality of handle members configured to be engaged by the fallen individual.

9. The lifting apparatus operable to autonomously traverse to the fallen individual as recited in claim 8, wherein in the second position the lifting member extends outward from the vertical support member and is horizontal in orientation allowing a fallen individual to move to an upper surface thereof.

10. The lifting apparatus operable to autonomously traverse to the fallen individual as recited in claim 9, wherein the lifting member is operable to traverse in an upwards-downwards direction on the vertical support member.

11. The lifting apparatus operable to autonomously traverse to the fallen individual as recited in claim 10, wherein in said first position the lifting member is adjacent to said vertical support member.

12. The lifting apparatus operable to autonomously traverse to the fallen individual as recited in claim 11, wherein the lifting apparatus is operable to move in the following directions: forward, rearwards and rotational.
